(19) United States
(12) Patent Application Publication
(10) Pub. No.: US 2024/0285114 A1
(43) Pub. Date: Aug. 29, 2024

(54) BEVERAGE BREWING SYSTEM AND METHOD

(71) Applicant: MASONTOPS IP HOLDINGS INC., Toronto (CA)

(72) Inventors: Michael Bacher, Toronto (CA); Philip Baron, Toronto (CA); Brett Molnar, Toronto (CA)

(21) Appl. No.: 18/113,419

(22) Filed: Feb. 23, 2023

(51) Int. Cl. A47J 31/20; A47J 31/44; A47J 31/46

(52) U.S. Cl. CPC A47J 31/20; A47J 31/446; A47J 31/467

(57) ABSTRACT

A beverage brewing system includes: a container configured to contain a solid substance, wherein the container includes an upper surface having an aperture and a lateral wall, wherein the container receives the solid substance through the aperture, and wherein the lateral wall is configured to allow the liquid to flow from a region exterior to the container into an interior region of the container; a first lid removably connectable to the container to substantially seal the aperture in the upper surface of the container, wherein the first lid is further removably connectable to the container, wherein the first lid comprises at least one aperture; and a second lid configured to removably connect to the first lid, wherein the second lid includes an aperture configured to allow a flow of the liquid through the aperture when the second lid is connected to the first lid.

### CROSS REFERENCE TO RELATED APPLICATIONS

Not applicable.

### BACKGROUND

Generally, this application relates to brewing beverages. Such beverages may be brewed using a solid substance, such as coffee grounds or tea leaves. The beverages may further be brewed using liquid of a given temperature (e.g., hot or cold).

### SUMMARY

According to embodiments, a beverage brewing system for brewing a beverage from a solid substance and a liquid, includes: a container configured to contain the solid substance, wherein the container includes an upper surface having an aperture and at least one lateral wall, wherein the container is configured to receive the solid substance through the aperture, and wherein the at least one lateral wall is configured to allow the liquid to flow from a region exterior to the container into an interior region of the container; a first lid configured to removably connect to the container to substantially seal the aperture in the upper surface of the container, wherein the first lid is further configured to removably connect to the container, wherein the first lid comprises at least one aperture; and a second lid configured to removably connect to the first lid, wherein the second lid includes an aperture configured to allow a flow of the liquid through the aperture when the second lid is connected to the first lid. The at least one aperture of the first lid may comprise a plurality of apertures arranged substantially circumferentially around a center axis of the first lid. The plurality of apertures may comprise a plurality of slits. The at least one lateral wall may comprise mesh. The container may comprise a lower wall including mesh. The first lid may include an upper surface comprising a recess. The second lid may further comprise a portion configured to selectively seal the aperture of the second lid. The beverage brewing system may further comprise a second container configured to contain the liquid, and the second container may be configured to removably connect with the first lid such that at least a portion of the container may be positioned within the second container when the second container may be connected to the first lid. The container may be configured to rotatably connect with the first lid. The second container may be configured to rotatably connect with the first lid. The container may be configured to rotatably connect with the first lid. The second lid may be configured to rotatably connect with the first lid. The second lid may comprise a handle, and wherein the first lid may not comprise a handle.

According to embodiments, a method for brewing a beverage from a solid substance and a liquid includes: adding the solid substance into an aperture in a first container, wherein the first container is liquid-permeable; connecting the first container to a lid, such that the solid substance cannot pass through the aperture; connecting the lid to a second container such that the first container is at least partially positioned within the second container; pouring a liquid into a recess in the lid; and allowing the liquid to flow through at least one aperture in the lid into the first container. The method may comprise connecting a second lid to the first lid, wherein the second lid comprises an aperture. The method may comprise selectively scaling the aperture in the second lid with a sealing portion of the second lid. The method may comprise tilting the connected first container, second container, lid, and second lid, such that the liquid flows from the first container, through the at least one aperture in the lid, and through the aperture of the second lid. The at least one aperture in the first container may comprise a plurality of apertures circumferentially arranged around a center axis of the lid. The plurality of apertures may comprise a plurality of slits. Said connecting the first container to the lid may comprise rotatably connecting the first container to the lid. Said connecting the lid to a second container may comprise rotatably connecting the lid to the second container.

### BRIEF DESCRIPTION OF SEVERAL VIEWS OF THE DRAWINGS

FIG. 1 illustrates a top perspective view of a beverage brewing system, according to embodiments.

FIG. 2 illustrates an exploded top perspective view of a beverage brewing system, according to embodiments.

FIG. 3 illustrates an exploded bottom perspective view of a beverage brewing system, according to embodiments.

FIG. 4 illustrates an exploded elevational view of a beverage brewing system, according to embodiments.

FIG. 5 illustrates a liquid being poured into a portion of a beverage brewing system containing a solid, according to embodiments.

FIG. 6 illustrates a liquid being poured out of a beverage brewing system containing a solid, according to embodiments.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the system.

### DETAILED DESCRIPTION

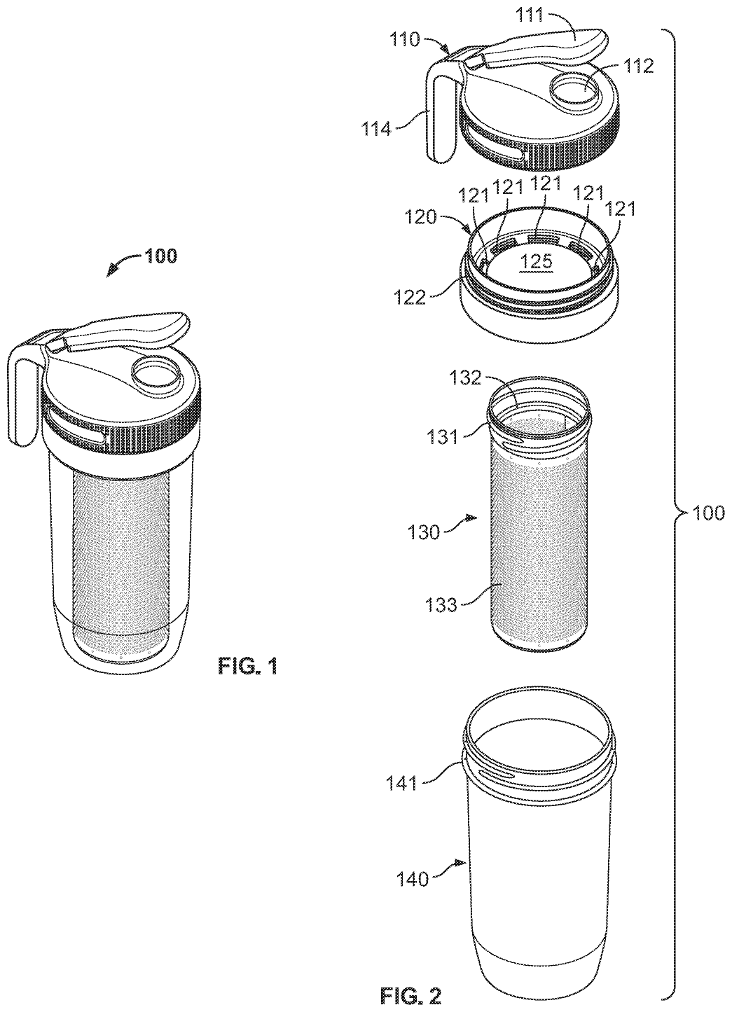

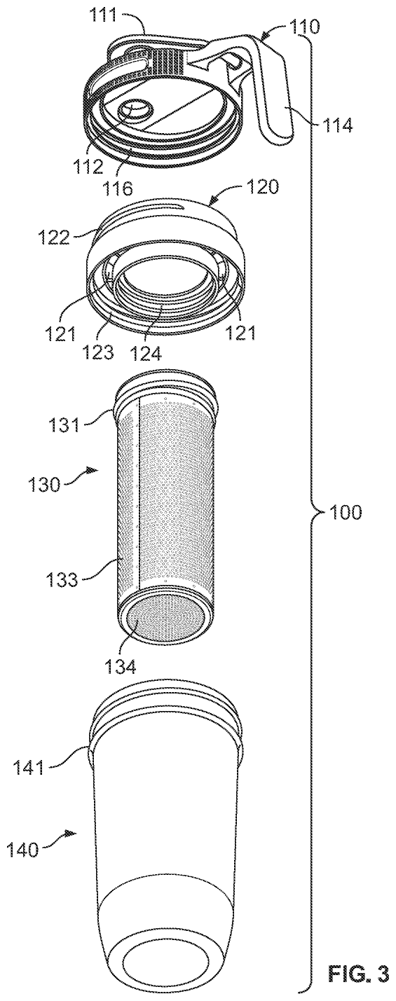

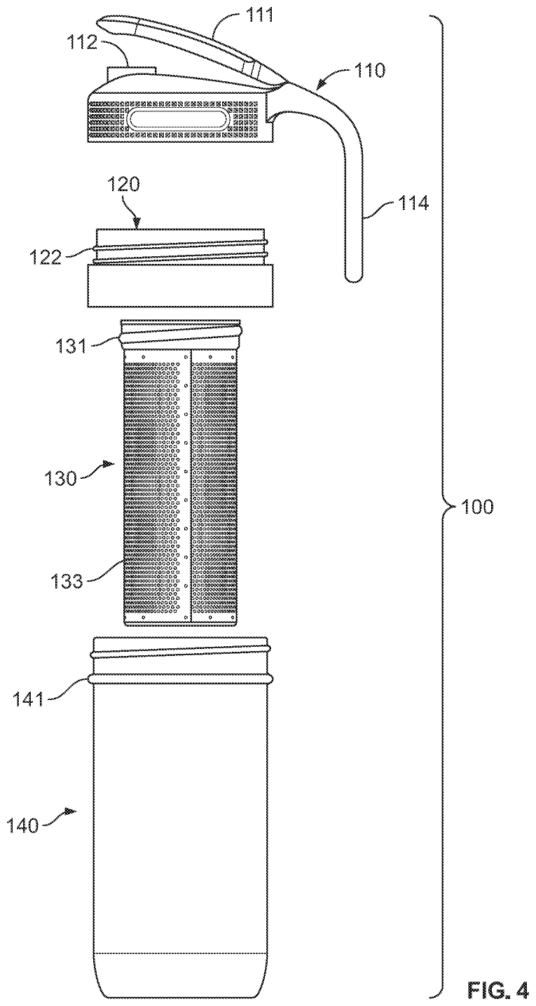

As shown in FIGS. 1-6, beverage brewing system 100 may include a first lid 120, a second lid 110, a first container 130, and a second container 140. The components of the beverage brewing system 100 may be removably connectable. Beverage brewing system 100 may be suitable for brewing a beverage using liquid 10 and solid substance 20, and for serving as a vessel from which a user can conveniently drink the beverage.

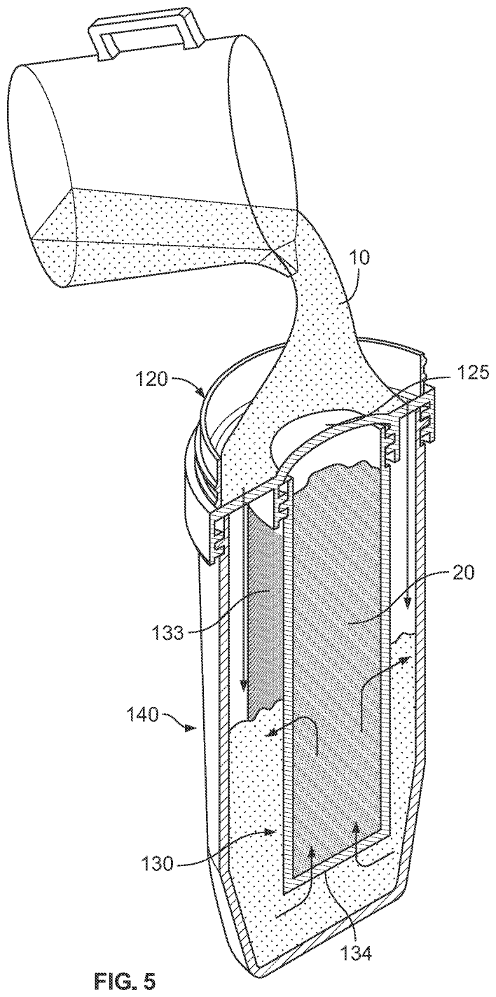

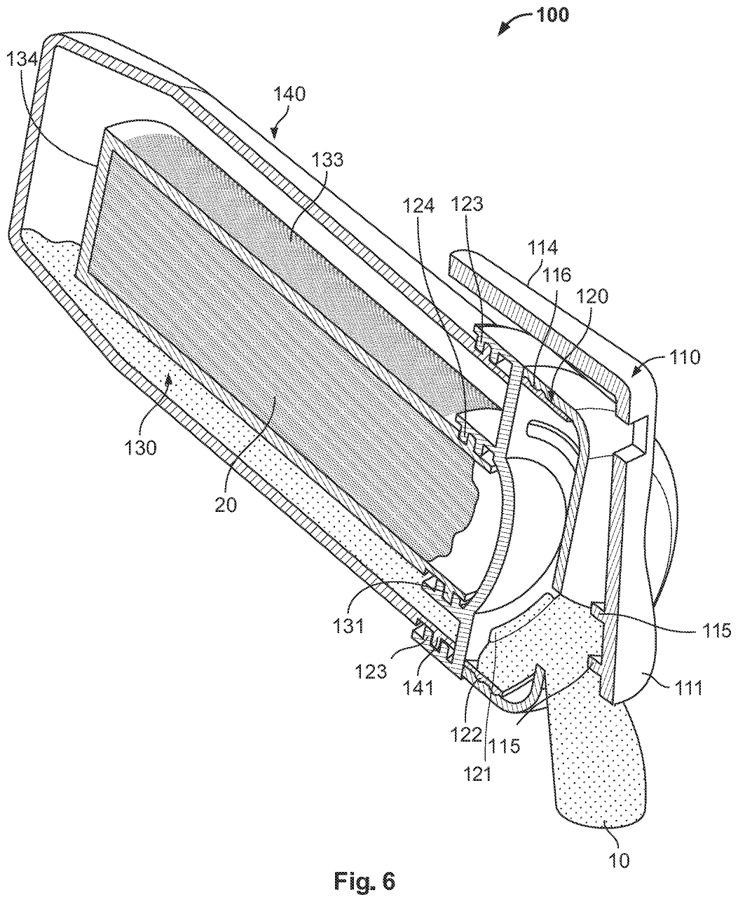

The first container 130 may include sidewall(s), including at least one lateral sidewall 133 and a lower sidewall 134. The first container 130 may further include an aperture 132 in an upper surface. The first container 130 may further include a connection feature 131 (e.g., threads) for connecting (e.g., rotatably connecting) the first container 130 to another component in the beverage brewing system 100. The lateral sidewall(s) 133 and/or lower sidewall 134 may include a porous material or liquid-permeable material. Such a material may be mesh, such as stainless steel mesh. The lateral sidewall(s) 133 and/or lower sidewall 134 may include a plurality of apertures to allow the flow of liquid. The apertures may be generally smaller than a diameter of a typical coffee ground, for example. As shown in FIGS. 5 and 6, the first container 130 may contain a solid substance 20, which may be added to the first container 130 through the aperture 132. Such a solid substance 20 may be coffee grounds or tea leaves. The apertures of lateral sidewall(s) 133 and/or lower sidewall 134 may be sufficiently small such as to prevent from the solid substance 20 from substantially passing through the apertures while allowing the flow of liquid 10. Instead of, or in addition to, solid substance 20, the first container 130 may be partially or completely filled with a viscous liquid (e.g., a gel or paste). Such a viscous liquid may or may not be completely contained by container 130 (e.g., it may seep through the sidewall(s) 133, 134.

The first container 130 may include a compressible portion (e.g., an overmolded portion, which is not shown) on an upper surface of the first container 130. The compressible portion may facilitate making a seal with the first lid 120 when connected. Such a scal may prevent the flow of liquid 10 and/or solid substance 20. Alternatively or in conjunction with the compressible portion, the beverage brewing system 100 may include a separate sealing portion (e.g., grommet) that will be interposed between the upper surface of the first container 130 and the lower surface of the first lid 120 when the components are connected.

The second container 140 may include non-porous or non-liquid-permeable sidewall(s) (e.g., lateral sidewall(s) and/or lower sidewall). The second container 140 may include an aperture 142 in an upper surface. The second container 140 may include a connection feature 141 (e.g., threads) in an upper region. The connection feature 141 may enable the second container 140 to connect (e.g., rotatably connect with threads) to another component in the beverage brewing system 100. The second container 140 may be transparent, translucent, or opaque. The second container 140 may comprise a material such as glass, metal, or plastic. The second container 140 may be substantially shatter resistant, for example, if it is dropped on a hard surface.

The second container 140 may include a compressible portion (e.g., an overmolded portion, which is not shown) on an upper surface of the second container 140. The compressible portion may facilitate making a seal with the first lid 120 when connected. Such a seal may prevent the flow of liquid 10 and/or solid substance 20. Alternatively or in conjunction with the compressible portion, the beverage brewing system 100 may include a separate sealing portion (e.g., grommet) that will be interposed between the upper surface of the second container 140 and the lower surface of the first lid 120 when the components are connected.

The first lid 120 may be an integrated piece. The first lid 120 may include a recess and aperture(s) 121. The apertures 121 may be positioned at a lower area of the recess. The recess may accommodate liquid 10 when it is poured into the first lid 120, and while the liquid 10 is draining out of apertures 121. The apertures 121 may be slits or may have other shapes. The apertures 121 may be circumferentially arranged around a central axis of the first lid 120, as shown. The first lid 120 may include a raised region 125 (e.g., a convex feature) with a maximum elevation above the aperture(s) 121. The raised region 125 may cause liquid 10 to flow through apertures 121. The raised region 125 may be substantially surrounded by apertures 121. Aperture(s) 121 may be located in a trench (e.g., a concave feature). The first lid 120 may include a first connection feature 124 (e.g., threads) for connecting with the first container 130 via connection feature 131 (e.g., rotatably connecting with threads). The first connection feature 124 may be located on a lower surface of the first lid 120. When the first lid 120 is connected to the first container 130, the solid substance 20 may be prevented from coming out of the aperture 132 of the first container 130. The first lid 120 may include a second connection feature 123 (e.g., threads) for connecting with a connection feature 141 the second container 140 (e.g., rotatably connecting with complimentary threads). The second connection feature 123 may be located on a lower surface of the first lid 120. The first lid 120 may include a third connection feature 122 (e.g., threads) for connecting with a connection feature 116 of the first lid 110 (e.g., rotatably connecting with complimentary threads). The third connection feature 122 may be located on an upper surface of the first lid 120.

The first lid 120 may include one or more compressible portions (e.g., overmolded portion(s), which is not shown) on an upper surface and/or a lower surface of the first lid 120. The compressible portion(s) may facilitate making seals with the second lid 120, first container 130, and/or second container 140 when connected. Such seal(s) may prevent the flow of liquid 10 and/or solid substance 20. Alternatively or in conjunction with the compressible portion, the beverage brewing system 100 may include separate scaling portion(s) (e.g., grommets) that will be interposed between the upper surface of the first lid 120 and the lower surface of the second lid 110 when the components are connected. And/or compressible portions on the first lid 120 or compressible portions may form seals with the first container 130 and/or the second container 140.

The second lid 110 may be an integrated piece. The second lid 110 may include a handle 114, an aperture 112, and a seal 115 to selectively seal the aperture 112. The handle 114 may be held by a user's hand, or may be arranged such that a user can slide a hand or fingers between the handle 114 and other portions of the beverage brewing system (e.g., second lid 110, first lid 120, and/or second container 140). The seal 115 may be attached to or integrated with a rotatable portion 111. The seal 115 may snap into and out of aperture 112 to prevent or allow liquid 10 to pass through the aperture 112. The second lid 110 may include a connection feature 116 (e.g., threads) for connecting with the connection feature 122 of the first lid 120 (rotatably connecting to complimentary threads). The connection feature 116 may be located on a lower surface of the second lid 110.

The second lid 110 may include a compressible portion (e.g., an overmolded portion, which is not shown) on a lower surface of the second lid 110. The compressible portion may facilitate making a seal with the first lid 120 when connected. Such a seal may prevent the flow of liquid 10 and/or solid substance 20. Alternatively or in conjunction with the compressible portion, the beverage brewing system 100 may include a separate sealing portion (e.g., grommet) that will be interposed between the lower surface of the second lid 110 and the upper surface of the first lid 120 when the components are connected.

The beverage brewing system 100 may be used in the following manner. A solid substance 20 (e.g., coffee grounds or tea leaves) may be poured or otherwise placed in first container 130 through aperture 132. The first container 130 may be partially or completely filled with solid substance 20. The connection feature 131 may then be engaged with complementary connection feature 124 on the first lid 120. These connection features 131, 124 may be complementary threads which allow for the first container 130 to rotatably connect with the first lid 120. Once connected, the first lid 120 may substantially cover the aperture 132 of the first container 130. As such, the solid substance 20 may be prevented from exiting the first container 130 through aperture 132. The first lid 120 (while connected with the first container 130) may then be connected with the second container 140, by engaging connection feature 123 of the first lid 120 with the connection feature 141 of the second container 140. The connection features 123, 141 may be complementary threads which allow for the second container 140 to be rotatably connected with the first lid 120. As shown in FIG. 5, liquid 10 (e.g., water) may be poured into the first lid 120. The liquid 10 may be any temperature (e.g., hot or cold). The first lid 120 may have a recess which allows the liquid 10 to pool. The raised feature 125 may tend to cause the liquid 10 to flow towards the apertures 121. The liquid 10 then flows through the apertures 121 into the second container 140. The liquid 10 then flows through the sidewalls 133, 134 of the first container 130 to mix, steep, soak, and/or infuse the solid substance 20. The solid substance 20 may be substantially prevented from passing through the sidewalls 133, 134. The second lid 110 may be connected with the first lid 120, for example via connection features 116, 122 (e.g., complementary threads that facilitate rotatable connection of the first lid 120 and the second lid 110). The liquid 10 may reside in the beverage brewing system 100 for a period of time—e.g., 2, 3, 4, 5, 6, 7, 8, 9, 10, or more minutes, or any suitable period of time to brew a beverage. The seal 115 may be removed from the aperture 112 in the second lid 110. For example, the rotatable portion 111 may be rotated, such that seal 115 is disengaged from the aperture 112. The beverage brewing system 100 may be tilted such that the liquid 10 (e.g., brewed beverage, subsequent to brewing) flows out of the second container 140 and through one or more of the apertures 121 in the first lid 120. The liquid 10 may then flow through the aperture 112 in the second lid 110, thereby exiting the beverage brewing system 100. The liquid 10 may be poured into another container (e.g., a mug) or may be poured into a user's mouth.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A beverage brewing system for brewing a beverage from a solid substance and a liquid, comprising:
a container configured to contain the solid substance, wherein the container includes an upper surface having an aperture and at least one lateral wall, wherein the container is configured to receive the solid substance through the aperture, and wherein the at least one lateral wall is configured to allow the liquid to flow from a region exterior to the container into an interior region of the container;
a first lid configured to removably connect to the container to substantially seal the aperture in the upper surface of the container, wherein the first lid is further configured to removably connect to the container, wherein the first lid comprises at least one aperture; and
a second lid configured to removably connect to the first lid, wherein the second lid includes an aperture configured to allow a flow of the liquid through the aperture when the second lid is connected to the first lid.

2. The beverage brewing system of claim 1, wherein the at least one aperture of the first lid comprises a plurality of apertures arranged substantially circumferentially around a center axis of the first lid.

3. The beverage brewing system of claim 2, wherein the plurality of apertures comprise a plurality of slits.

4. The beverage brewing system of claim 1, wherein the at least one lateral wall comprises mesh.

5. The beverage brewing system of claim 1, wherein the container further comprises a lower wall including mesh.

6. The beverage brewing system of claim 1, wherein the first lid includes an upper surface comprising a recess.

7. The beverage brewing system of claim 1, wherein the second lid further comprises a portion configured to selectively seal the aperture of the second lid.

8. The beverage brewing system of claim 1, further comprising a second container configured to contain the liquid, and further configured to removably connect with the first lid such that at least a portion of the container is positioned within the second container when the second container is connected to the first lid.

9. The beverage brewing system of claim 1, wherein the container is configured to rotatably connect with the first lid, and wherein the second container is configured to rotatably connect with the first lid.

10. The beverage brewing system of claim 1, wherein the container is configured to rotatably connect with the first lid.

11. The beverage brewing system of claim 10, wherein the second lid is configured to rotatably connect with the first lid.

12. The beverage brewing system of claim 1, wherein the second lid comprises a handle, and wherein the first lid does not comprise a handle.

13. A method for brewing a beverage from a solid substance and a liquid, the method comprising:
adding the solid substance into an aperture in a first container, wherein the first container is liquid-permeable;
connecting the first container to a lid, such that the solid substance cannot pass through the aperture;
connecting the lid to a second container such that the first container is at least partially positioned within the second container;
pouring a liquid into a recess in the lid; and
allowing the liquid to flow through at least one aperture in the lid into the first container.

14. The method of claim 13, further comprising connecting a second lid to the first lid, wherein the second lid comprises an aperture.

15. The method of claim 14, further comprising selectively sealing the aperture in the second lid with a sealing portion of the second lid.

16. The method of claim 14, further comprising tilting the connected first container, second container, lid, and second lid, such that the liquid flows from the first container, through the at least one aperture in the lid, and through the aperture of the second lid.

17. The method of claim 13, wherein the at least one aperture in the first container comprises a plurality of apertures circumferentially arranged around a center axis of the lid.

18. The method of claim 17, wherein the plurality of apertures comprise a plurality of slits.

19. The method of claim 13, wherein said connecting the first container to the lid comprises rotatably connecting the first container to the lid.

20. The method of claim 13, wherein said connecting the lid to a second container comprises rotatably connecting the lid to the second container.
